(19) United States
(12) Patent Application Publication
(10) Pub. No.: US 2019/0011629 A1
(43) Pub. Date: Jan. 10, 2019

(54) ARTICLE WITH MICROSTRUCTURED LAYER

(71) Applicant: 3M INNOVATIVE PROPERTIES COMPANY, St. Paul, MN (US)

(72) Inventors: Jeffrey L. Solomon, Vadnais Heights, MN (US); Elisa M. Cross, Woodbury, MN (US)

(73) Assignee: 3M INNOVATIVE PROPERTIES COMPANY, St. Paul, MN (US)

(21) Appl. No.: 16/067,023

(22) PCT Filed: Dec. 22, 2016
(86) PCT No.: PCT/US2016/068304

§ 371 Date: Jun. 28, 2018

Related U.S. Application Data
(60) Provisional application No. 62/271,602, filed on Dec. 28, 2015.

(51) Int. Cl. F21V 8/00

(52) U.S. Cl. CPC G02B 6/0051; G02B 6/0055

(57) ABSTRACT

Article comprising a first, microstructured layer having first and second opposed major surfaces, the first major surface being a microstructured surface; a second layer comprising an adhesive material, and having a first and second opposed major surfaces, wherein at least a portion of the second major surface of the second layer is directly attached to at least a portion of the first major, microstructured surface of the first layer; and a third layer comprising at least one of a crosslinkable or crosslinked composition, and having first and second opposed major surfaces, and wherein at least a portion of the second major surface of the third layer is directly attached to at least a portion of the first major surface of the second layer. Articles described herein are useful, for example, for optical film applications. For example, an article including a regular prismatic microstructured pattern can act as a totally internal reflecting film for use as a brightness enhancement film; an article including a corner-cube prismatic microstructured pattern can act as a retroreflecting film or element for use as reflecting film when combined with a back reflector; and an article including a prismatic microstructured pattern can act as an optical turning film or element for use in an optical display.

### BACKGROUND

Microstructured films can be useful in optical displays. For example, a prismatic microstructured film can act a brightness enhancement film. Two or more microstructured films can be used together in many kinds of optical displays. In addition, one or more other optical films may be used in optical displays in conjunction with one or more microstructured films. These microstructured films and other optical films are typically manufactured separately and incorporated into the optical display at the time of its manufacture, or are incorporated into a sub-assembly or component, that is intended for incorporation into an optical display, at the time of its manufacture. This can be an expensive, time, and/or labor-intensive manufacturing step. Some such microstructured films and other optical films are designed to include layers whose purpose is to provide stiffness or other advantages in handling during film manufacture, film converting, film transport, and optical display or sub-assembly component manufacture. This can add thickness and weight to such films beyond what would be necessary to fulfill their optical functions. Sometimes such microstructured films and other optical films are adhered to one another using an adhesive layer or layers when the optical display or sub-assembly component is manufactured. This too can add thickness and weight to the optical display or sub-assembly component, and it can sometimes also adversely affect the optics. Sometimes such microstructured films and other optical films must be very precisely arranged in an optical display in order for their principal optical axes to lie at precise angles to one another. This can be an expensive, time, and/or labor intensive manufacturing step, and even slight misalignment can adversely affect optical performance. There is a need for additional microstructured film constructions, including those that address or improve one of the drawbacks discussed above.

### SUMMARY

In one aspect, the present disclosure describes an article comprising:

a first, microstructured layer comprising a first material, and having first and second opposed major surfaces, the first major surface being a microstructured surface, and the microstructured surface having peaks and valleys, wherein the peaks are microstructural features each having a height defined by the distance between the peak of the respective microstructural feature and an adjacent valley;

a second layer comprising an adhesive material, and having a first and second opposed major surfaces, wherein at least a portion of the second major surface of the second layer is directly attached to at least a portion of the first major, microstructured surface of the first layer; and

a third layer comprising at least one of a crosslinkable or crosslinked composition, and having first and second opposed major surfaces, wherein at least a portion of the second major surface of the third layer is directly attached to at least a portion of the first major surface of the second layer. In some embodiments, the third layer is a microstructured layer, wherein the first major surface is a microstructured surface, and the microstructured surface has peaks and valleys, wherein the peaks are microstructural features each having a height defined by the distance between the peak of the respective microstructural feature and an adjacent valley.

In another aspect, the present disclosure describes a method of making articles described herein, the method comprising:

providing a composite comprising first and second layers each having first and second opposed major surfaces, the first major surface of the second layer being attached to the second major surface of the first layer; and

laminating a third layer having a first and second opposed major surfaces to the composite such that the first major surface of the third layer is attached to the second major surface of the second layer, wherein the first major surface of the third layer is a microstructured surface having microstructural features. In some embodiments, the first major surface of the first layer is a microstructured surface having microstructural features.

Articles described herein are useful, for example, in optical film applications. For example, an article including a regular prismatic microstructured pattern can act as a totally internal reflecting film for use as a brightness enhancement film when combined with a back reflector; an article including a corner-cube prismatic microstructured pattern can act as a retroreflecting film or element for use as reflecting film; and an article including a prismatic microstructured pattern can act as an optical turning film or element for use in an optical display.

### BRIEF DESCRIPTION OF THE DRAWINGS

FIGS. 1 and 1A are cross-sectional views of an exemplary article described herein.

FIG. 2A is a scanning electron microscopy (SEM) photomicrograph of the Example 1 article at 1900× cut perpendicular to the prisms of the first microstructured layer.

FIG. 2B is an SEM photomicrograph of the Example 1 article at 1900× cut perpendicular to the prisms of the third microstructured layer.

FIG. 3A is an SEM photomicrograph of the Example 2 article at 1900× cut perpendicular to the prisms of the first microstructured layer.

FIG. 3B is an SEM photomicrograph of the Example 2 article at 1900× cut perpendicular to the prisms of the third microstructured layer.

FIG. 4A is an SEM photomicrograph of the Example 3 article at 1900× cut perpendicular to the prisms of the first microstructured layer.

FIG. 4B is an SEM photomicrograph of the Example 3 article at 1900× cut perpendicular to the prisms of the third microstructured layer.

FIG. 5A is an SEM photomicrograph of the Example 4 article at 1900× cut perpendicular to the prisms of the first microstructured layer.

FIG. 5B is an SEM photomicrograph of the Example 4 article at 1900× cut perpendicular to the prisms of the third microstructured layer.

FIG. 6A is an SEM photomicrograph of the Example 5 article at 2000× cut perpendicular to the prisms of first microstructured layer.

FIG. 6B is an SEM photomicrograph of the Example 5 article at 2000× cut perpendicular to the prisms of the third microstructured layer.

### DETAILED DESCRIPTION

Exemplary articles described herein comprise, in order, an optional diffuser layer, an optional adhesive layer, an optional polymeric layer, an optional diffuser layer, a microstructured layer, an adhesive layer, a layer (in some embodiments, the layer is optionally a microstructured layer), an optional adhesive layer, an optional polymeric layer, and an optional adhesive layer.

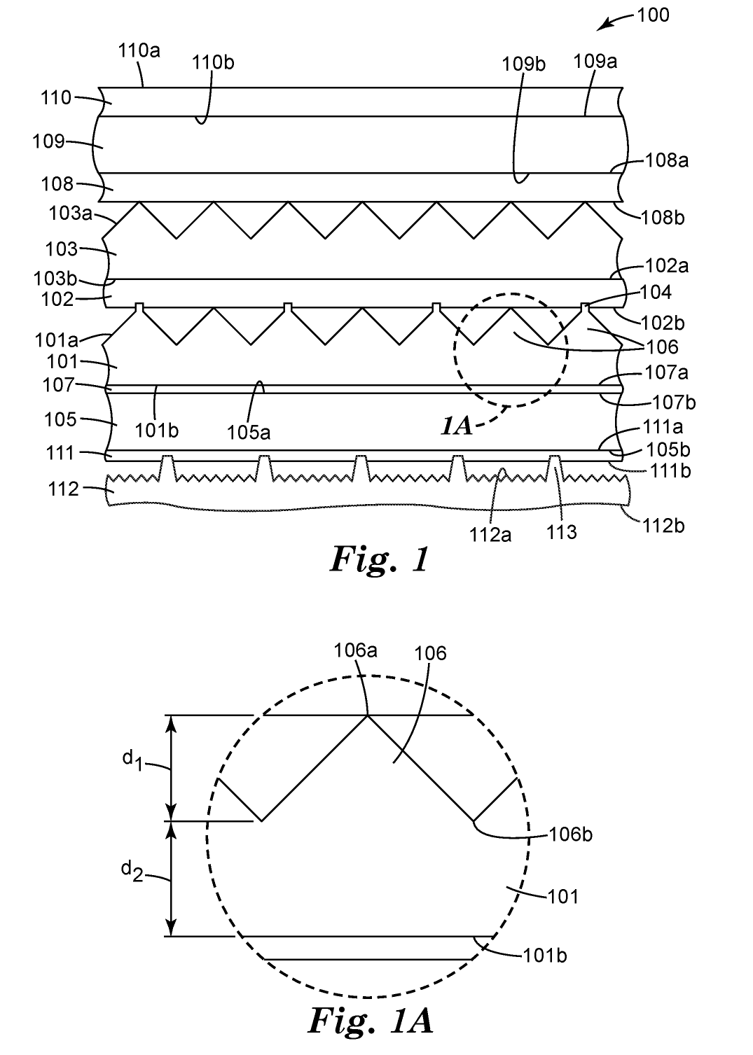

Referring to FIGS. 1 and 1A, exemplary article 100 comprises optional diffuser layer 112, optional adhesive layer 111, optional polymeric layer 105, optional diffuser layer 107, microstructured layer 101, adhesive layer 102, layer (as shown a microstructured layer) 103, optional adhesive layer 108, optional polymeric layer 109, and optional adhesive layer 110. Microstructured layer 101 has first and second opposed major surfaces 101a, 101b. Major surface 101a is a microstructured surface. Adhesive layer 102 has first and second opposed major surfaces 102a, 102b. At least a portion of major surface 101a is directly attached to major surface 102b. As shown, portion 104 of microstructured surface 101a penetrates into adhesive layer 102. Microstructured surface 101a has microstructural features 106 with peaks 106a and valleys 106b, wherein each microstructure feature has height, d₁, as measured from a peak (106a) to the lowest adjacent valley (106b). It is understood that the height measurement is the height perpendicular to surface 101b. Microstructured layer 101 has thickness, d₂, as measured from the lowest adjacent valley (106b) to major surface 101b. Microstructured layer 103 has first and second opposed major surfaces 103a, 103b. Major surface 103a is a microstructured surface. At least a portion of major surface 102a is directly attached to major surface 103b.

Optional diffuser layer 112 has first and second major surfaces 112a, 112b. Optional adhesive layer 111 has first and second major surfaces 111a and 111b. As shown portion 113 of optional diffuser surface 112a penetrates into optional adhesive layer 111. Optional diffuser layer 107 has first and second opposed major surfaces 107a, 107b. As shown, major surface 107a is directly attached at least in part to major surface 101b. Optional polymeric layer 105 has first and second opposed major surfaces 105a, 105b. As shown, major surface 111a is directly attached at least in part to major surface 105b. As shown, major surface 105a is directly attached at least in part to major surface 107b. Optional adhesive layer 108 has first and second opposed major surfaces 108a, 108b. As shown, major surface 108b is directly attached at least in part to major surface 103a. Optional polymeric layer 109 has first and second opposed major surfaces 109a, 109b. As shown, major surface 109b is directly attached at least in part to major surface 108a. Optional adhesive layer 110 has first and second opposed major surfaces 110a, 110b. As shown, major surface 110b is directly attached at least in part to major surface 109a. If any optional layer is not present, the respective adjacent major surfaces of layers present may be directly attached.

In general, techniques for making microstructured layers are known in the art (see, e.g., U.S. Pat. No. 5,182,069 (Wick), U.S. Pat. No. 5,175,030 (Lu et al.), U.S. Pat. No. 5,183,597 (Lu), and U.S. Pat. No. 7,074,463 B2 (Jones et al.), the disclosures of which are incorporated herein by reference).

Conventional microstructured layers made from crosslinkable materials are typically a composite construction of a crosslinked microstructured layer attached to a polymer film (e.g., polyester film) composed of a different material. Monolithic microstructured layers made of crosslinkable materials, however, are also known in the art (see, e.g., U.S. Pat. No. 4,576,850 (Martens). The third layer of articles described herein, which in some embodiments is a microstructured layer, has at least a portion directly attached to the adhesive layer which in turn has at a portion directly attached to the first microstructured layer. That is, there is no intervening layer except for the adhesive layer, including no polymer layer, between the microstructured surfaces of the first microstructured layer and the third layer. This construction allows even a relatively thin crosslinked microstructured layer that is not robust enough to be handled independently (due, for example, to its thinness or composition) in typical industrial process (e.g., continuous or semi-continuous web processing) to be combined with other layers to form the articles described herein. By removing the polymer layer between the microstructured surfaces, the articles described herein can provide for a reduction in thickness while providing comparable optical performance.

Microstructured layers for articles described herein can be formed, for example, by coating a crosslinkable composition onto a tooling surface, crosslinking the crosslinkable composition and removing the microstructured layer from the tooling surface. Microstructured layers for articles described herein can also be formed, for example, by coating a crosslinkable composition onto a tooling surface, applying a polymeric layer, crosslinking the crosslinkable composition and removing the tooling surface and optionally the polymeric layer. Microstructured layers comprising two microstructured surfaces can, for example, be formed by coating a crosslinkable composition onto a tooling surface, applying a polymeric layer wherein the major surface of the polymer layer in contact with the crosslinkable composition is a microstructured surface, crosslinking the crosslinkable composition and removing the tooling surface and the polymeric layer. Microstructured layers for articles described herein can also be formed, for example, by extruding a molten thermoplastic material onto a tooling surface, cooling the thermoplastic material and removing the tooling surface. The microstructures can have a variety of patterns, including at least one of regular prismatic, irregular prismatic patterns (e.g., an annular prismatic pattern, a cube-corner pattern or any other lenticular microstructure), non-periodic protuberances, pseudo-non-periodic protuberances, or non-periodic depressions, or pseudo-non-periodic depressions. The same techniques can be used to provide the third layer, even if it is not a microstructured layer, in which case the tool surface, for example, is simply planar.

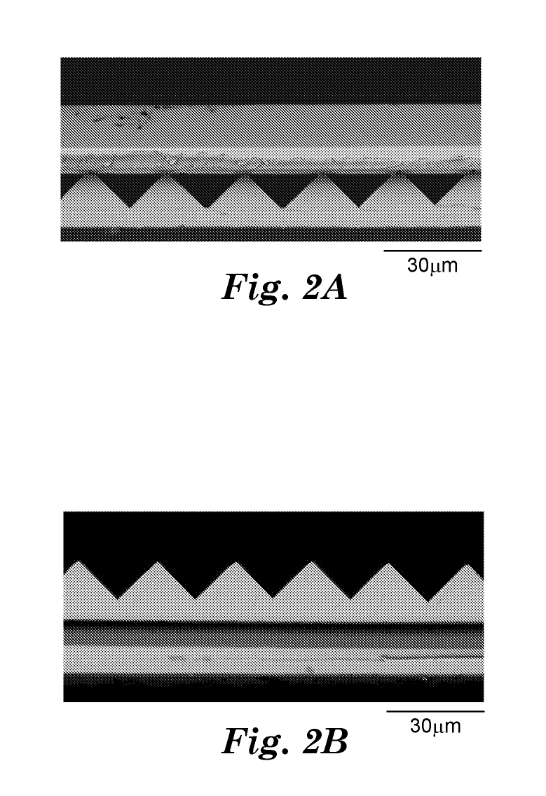

If the microstructural features of a microstructured layer have a directionality (e.g., linear structures such as prisms), the directionality of the microstructural features may be oriented at any angle. The prisms of a microstructured layer could, for example, be parallel or perpendicular or at any other angle relative to the microstructural features of another layer. For example, the prisms of the first microstructured layer and the prisms of third microstructured layer of the Example 1 article are oriented perpendicular to each other (FIGS. 2A and 2B).

Microstructured layers can comprise, for example, a crosslinkable or crosslinked composition or thermoplastic material. Exemplary crosslinkable or crosslinked compositions include resin compositions which may be curable or cured by a free radical polymerization mechanism. Free radical polymerization can occur by exposure to radiation (e.g., electron beam, ultraviolet light, and/or visible light) and/or heat. Exemplary suitable crosslinkable or crosslinked composition also include those polymerizable, or polymerized, thermally with the addition of a thermal initiator such as benzoyl peroxide. Radiation-initiated cationically polymerizable resins also may be used. Suitable resins may be blends of photoinitiator and at least one compound bearing an (meth)acrylate group.

Exemplary resins capable of being polymerized by a free radical mechanism include acrylic-based resins derived from epoxies, polyesters, polyethers, and urethanes, ethylenically unsaturated compounds, aminoplast derivatives having at least one pendant (meth)acrylate group, isocyanate derivatives having at least one pendant (meth)acrylate group, epoxy resins other than (meth)acrylated epoxies, and mixtures and combinations thereof. The term (meth)acrylate is used here to encompass both the acrylate and methacrylate compound where ever both the acrylate and methacrylate compound exist. Further details on such resins are reported in U.S. Pat. No. 4,576,850 (Martens), the disclosure of which is incorporated herein by reference.

Ethylenically unsaturated resins include both monomeric and polymeric compounds that contain atoms of carbon, hydrogen and oxygen, and optionally nitrogen, sulfur, and halogens. Oxygen or nitrogen atoms, or both, are generally present in ether, ester, urethane, amide, and urea groups. In some embodiments, ethylenically unsaturated compounds have a number average molecular weight of less than about 4,000 (in some embodiments, are esters made from the reaction of compounds containing aliphatic monohydroxy groups, aliphatic polyhydroxy groups, and unsaturated carboxylic acids (e.g., acrylic acid, methacrylic acid, itaconic acid, crotonic acid, iso-crotonic acid, and maleic acid)). Some illustrative examples of compounds having an acrylic or methacrylic group that are suitable for use in the invention are listed below:

(1) Monofunctional compounds: ethyl (meth)acrylate, n-butyl (meth)acrylate, isobutyl (meth)acrylate, 2-ethylhexyl (meth)acrylate, n-hexyl (meth)acrylate, n-octyl (meth)acrylate, isooctyl (meth)acrylate, bornyl (meth)acrylate, tetrahydrofurfuryl (meth)acrylate, 2-phenoxyethyl (meth)acrylate, and N,N-dimethylacrylamide;

(2) Difunctional compounds: 1,4-butanediol di(meth)acrylate, 1,6-hexanediol di(meth)acrylate, neopentylglycol di(meth)acrylate, ethylene glycol di(meth)acrylate, triethyleneglycol di(meth)acrylate, tetraethylene glycol di(meth)acrylate, and diethylene glycol di(meth)acrylate; and

(3) Polyfunctional compounds: trimethylolpropane tri(meth)acrylate, glycerol tri(meth)acrylate, pentaerythritol tri(meth)acrylate, pentaerythritol tetra(meth)acrylate, and tris(2-acryloyloxyethyl) isocyanurate.

Some representatives of other ethylenically unsaturated compounds and resins include styrene, divinylbenzene, vinyl toluene, N-vinyl formamide, N-vinyl pyrrolidone, N-vinyl caprolactam, monoallyl, polyallyl, and polymethallyl esters such as diallyl phthalate and diallyl adipate, and amides of carboxylic acids such as N,N-diallyladipamide. In some embodiments, at least two (meth)acrylate or ethylenically unsaturated components may be present in the crosslinkable or crosslinked resin composition.

If the resin composition is to be cured by radiation, other than by electron beam, then a photoinitiator may be included in the resin composition. If the resin composition is to be cured thermally, then a thermal initiator may be included in the resin composition. In some embodiments, a combination of radiation and thermal curing may be used. In such embodiments, the composition may include both a photoinitiator and a thermal initiator.

Exemplary photoinitiators that can be blended in the resin include the following: benzil, methyl o-benzoate, benzoin, benzoin ethyl ether, benzoin isopropyl ether, benzoin isobutyl ether, etc., benzophenone/tertiary amine, acetophenones (e.g., 2,2-diethoxyacetophenone, benzyl methyl ketal, 1-hydroxycyclohexylphenyl ketone, 2-hydroxy-2-methyl-1-phenylpropan-1-one, 1-(4-isopropylphenyl)-2-hydroxy-2-methylpropan-1-one, 2-benzyl-2-N,N-dimethylamino-1-(4-morpholinophenyl)-1-butanone, 2,4,6-trimethylbenzoyl-diphenylphosphine oxide, 2-methyl-1-4(methylthio), phenyl-2-morpholino-1-propanone, bis(2,4,6-trimethylbenzoyl)-phenylphosphine oxide and bis(2,6-dimethoxybenzoyl)(2,4,4-trimethylpentyl)phosphine oxide). The compounds may be used individually or in combination. Cationically polymerizable materials include materials containing epoxy and vinyl ether functional groups. These systems are photoinitiated by onium salt initiators, such as triarylsulfonium, and diaryliodonium salts. Other exemplary crosslinkable or crosslinked resin compositions are described, for example, in U.S. Pat. No. 8,986,812 B2 (Hunt et al.), U.S. Pat. No. 8,282,863 B2 (Jones et al.), and PCT Pub. No. WO 2014/46837, published Mar. 27, 2014, the disclosures of which are incorporated herein by reference.

Exemplary materials used in crosslinkable compositions are available, for example, from Sartomer Company, Exton Pa.; Cytec Industries, Woodland Park, N.J.; Soken Chemical, Tokyo, Japan; Daicel (USA), Inc., Fort Lee, N.J.; Allnex, Brussels, Belgium; BASF Corporation, Charlotte, N.C.; Dow Chemical Company, Midland, Mich.; Miwon Specialty Chemical Co. Ltd., Gyoenggi-do, Korea; Hampford Research Inc., Stratford, Conn.; and Sigma Aldrich, St Louis, Mo.

In some embodiments, the first material of a microstructured layer comprises at least one of a crosslinkable or crosslinked composition. In some embodiments, a microstructured layer consists essentially of the crosslinked material.

Crosslinkable materials can be partially crosslinked by techniques known in the art, including actinic radiation (e.g., e-beam or ultraviolet light). Techniques for partially crosslinking a crosslinkable material include exposing an (meth)acrylate moiety containing composition to actinic radiation in the presence of an oxygen containing atmosphere. The (meth)acrylate containing composition can be further crosslinked by exposure to actinic radiation in an atmosphere substantially free of oxygen. Techniques for partially crosslinking a crosslinkable composition further include using a crosslinkable composition that comprises components that react with more than one type of crosslinking reaction where the reactions can initiated independently (e.g., a mixture containing both epoxy components that can be crosslinked by cationic polymerization and (meth)acrylate components that can be crosslinked by free radical polymerization). The crosslinkable composition can be partially crosslinked at a short time after initiating the crosslinking reaction (e.g., a cationic polymerization of an epoxy). The partially crosslinked composition can be further cured by techniques known in the art such as actinic radiation (e.g., e-beam or ultraviolet light).

Exemplary thermoplastic materials include those materials that can be processed by thermoplastic processing techniques such as extrusion. Exemplary thermoplastic materials include polyethylene, polypropylene, polymethyl methacrylate, polycarbonate, and polyester.

In some embodiments, both major surfaces of a microstructured layer include a microstructured surface. In some embodiments, a microstructured layer has a thickness defined by the smallest distance from any valley to the second major surface of the first, microstructured layer, and wherein the thickness is not greater than 25 micrometers (in some embodiments, not greater than 20 micrometers, 15 micrometers, or even not greater than 10 micrometers.

In some embodiments, the height of a microstructural feature of microstructured layer is in the range from 1 micrometer to 200 micrometers (in some embodiments, in the range from 1 micrometer to 150 micrometers, 5 micrometers to 150 micrometers, or even 5 micrometers to 100 micrometers).

In some embodiments, a portion of each of the microstructural features of the first, microstructured layer at least partially penetrates into the second material of the second layer (in some embodiments, the first, microstructured layer at least partially penetrates into the second material of the second layer to a depth less than the average height of the respective microstructural feature). In some embodiments, the penetration depth of the each penetrating microstructural feature is not greater than 50 (in some embodiments, not greater than 45, 40, 35, 30, 25, 20, 15, 10, or even not greater than 5) percent of the respective height of the microstructural feature. The foregoing can also apply to other microstructural layers with regard to microstructural features adjacent to the major surface of an adjacent layer.

Exemplary adhesive materials include an interpenetrating network of the reaction product of a polyacrylate component and a polymerizable monomer (see, e.g., U.S. Pat. Pub. No. US2014/0016208 A1 (Edmonds et al.), the disclosure of which is incorporated herein by reference).

Another exemplary adhesive comprises a reaction product of a mixture comprising (meth)acrylate and epoxy in the presence of each other. In some embodiments, the (meth)acrylate is present in a range from 5 to 95 (in some embodiments, in a range from, 10 to 90 or even 20 to 80) percent by weight and the epoxy is present in a range from 5 to 95 (in some embodiments, in a range from 5 to 95, 10 to 90, or even 20 to 80) percent by weight, based on the total weight of the mixture. Exemplary (meth)acrylates include monofunctional (meth)acrylate compounds (e.g., ethyl(meth)acrylate, n-butyl(meth)acrylate, isobutyl(meth)acrylate, 2-ethylhexyl(meth)acrylate, n-hexyl(meth)acrylate, n-octyl(meth)acrylate, isooctyl (meth)acrylate, isobornyl (meth)acrylate, tetrahydrofurfuryl (meth)acrylate, 2-phenoxyethyl (meth)acrylate, methoxy polyethylene glycol mono(meth)acrylate and N,N-dimethylacrylamide), difunctional (meth)acrylate materials (e.g., 1,4-butanediol di(meth)acrylate, 1,6-hexanediol di(meth)acrylate, neopentylglycol di(meth)acrylate, ethylene glycol di(meth)acrylate, triethyleneglycol di(meth)acrylate, tetraethylene glycol di(meth)acrylate, diethylene glycol di(meth)acrylate and polyfunctional (meth)acrylate materials (e.g., trimethylolpropane tri(meth)acrylate, ethoxylate trimethylolpropane tri(meth)acrylate, glyceroltri(meth)acrylate, pentaerythritol tri(meth)acrylate, and pentaerythritol tetra(meth)acrylate). In some embodiments, at least two (meth)acrylate components may be used in the adhesive material. Exemplary epoxies include (3-4-epoxycyclohexane) methyl 3′-4′-epoxycyclohexyl-carboxylate, bis(3,4-epoxycyclohexylmethyl) adipate, 4-vinyl-1-cyclohexene 1,2-epoxide, polyethylene glycol diepoxide, vinylcyclohexene dioxide, neopentyl glycol diglycidyl ether and 1,4-cyclohexanedimethanol bis(3,4-epoxycyclohexanecarboxylate. In some embodiments, the (meth)acrylate and the epoxy are present on the same molecule (e.g., (3-4-epoxycyclohexyl) methyl acrylate, 3,4-epoxycyclohexylmethyl methacrylate, glycidyl (meth)acrylate, and 4-hydroxybutyl (meth)acrylate glycidylether). In some embodiments, the mixture further comprises polyol functionalities (e.g., polyethylene glycol, polyester diol derived from caprolactone monomer, polyester triol derived from caprolactone monomer). In some embodiments, the mixture is substantially free of monofunctional (meth)acrylates (i.e., contains less than 10 percent by weight of monofunctional (meth)acrylates, based on the total weight of the adhesive material). In some embodiments, the (meth)acrylate and the epoxy do not react with each other.

Exemplary adhesive materials also include pressure sensitive adhesives, optically clear adhesives and structural adhesives known in the art. Exemplary adhesive materials also include crosslinkable compositions.

In some embodiments, it may be desirable to incorporate diffusion (i.e., a coating or coatings or a layer or layers that diffuse(s) light, or elements within an existing layer that diffuse light) in order, for example, to reduce the visibility of optical defects. In some embodiments, a layer comprising adhesive material further comprises a filler material (e.g., glass beads, polymer beads, inorganic particles such as fumed silica). In some embodiments, an adhesive layer may be discontinuous or patterned (e.g., an array of regular or irregular dots).

Exemplary polymeric layers include those comprising polyester, polycarbonate, cyclic olefin copolymer or polymethyl methacrylate. Exemplary polymeric layers include multilayer optical films including reflective polarizing film (available, for example, under the trade designation “DUAL BRIGHTNESS ENHANCEMENT FILM” or “ADVANCED POLARIZING FILM” available from 3M Company, St Paul, Minn.) or reflecting films (available, for example, under the trade designation “ENHANCED SPECULAR REFLECTOR” available from 3M Company). Exemplary polymeric layers include light guides used in optical display. In some embodiments, exemplary polymeric layers include diffuser layers.

Exemplary diffuser layers include bulk diffusers and surface diffusers known in the art.

Exemplary diffuser layers include an embedded microstructured layer or a layer comprising a filler material, and can be prepared by techniques known in the art. Embedded microstructured layers can be prepared, for example, by creating the microstructural features on the desired surface using a material with a refractive index (e.g., polymeric or cross linkable material) and then coating a different material with a different refractive index (e.g., polymeric or cross linkable material) over the microstructural features. A diffuse layer comprising a filler material can be prepared, for example, by combining a filler material with a refractive index with a polymeric or crosslinkable material with a different refractive index and applying or coating the diffuse mixture onto the desired surface.

Exemplary diffuser layers include layers with a microstructured surface on one or both major surfaces (available, for example, under the trade designation “ULTRA DIFFUSER FILM” available from 3M Company). Exemplary diffuser layers include color conditioning diffusers (available, for example, under the trade designation “3M QUANTUM DOT ENHANCEMENT FILM” available from 3M Company). In some embodiments, only a portion of the microstructured surface of the diffuser layer is attached to an adjacent layer.

In some embodiments, a diffuser layer may be comprised of multiple layers (e.g., a combination of two or more of a cross-linked layer(s), microstructured layer(s), polymeric layer(s), or layer(s) comprising filler material).

In another aspect, the present disclosure describes a method of making articles described herein, the method comprising:

providing a composite comprising first and second layers each having first and second opposed major surfaces, wherein the first major surface of the second layer is attached to the second major surface of the first layer; and

laminating a third layer having a first and second opposed major surfaces to the composite such that the first major surface of the third layer is attached to the second major surface of the second layer, wherein the first major surface of the third layer is a microstructured surface having microstructural features. In some embodiments, the first major surface of the first layer is a microstructured surface having microstructural features.

In some embodiments, the method further comprises attaching a polymeric layer (e.g., a polyester layer or multilayer optical film (e.g., polarizing film or reflecting film)) to the second major surface of the third layer.

In some embodiments, the third, microstructured layer is provided by coating a resin upon a tooling surface, curing the resin, and removing the third, microstructured layer from the tooling surface, wherein the tooling surface is a mold for forming the microstructured first major surface of the microstructured third layer. The third microstructured layer can be formed, for example, by applying a crosslinkable material onto a tooling surface, pressing a flexible polymeric film that does not adhere to the crosslinked material to the coated tooling surface, crosslinking the crosslinkable material, removing the polymeric film and removing the third microstructured layer.

In some embodiments, the method, further comprises attaching the polymeric layer to the second major surface of the third, microstructured layer prior to curing the resin. The third microstructured layer can be formed, for example, by applying crosslinkable material onto a tooling surface, pressing a flexible polymeric film that does adhere to the crosslinked material to the coated tooling surface, crosslinking the crosslinkable material, removing third microstructured layer with second major surface of third microstructured layer attached to the polymeric film.

In some embodiments, during the laminating, the microstructural features of the microstructured surface of the third layer penetrate into the second major surface of the second layer.

In some embodiments, it is desirable to control the penetration depth of the microstructural features of the third layer into the second major surface of the second layer. The penetration depth can be controlled, for example, by controlling the thickness of the second layer. The penetration depth can also be controlled by increasing the viscosity of the second layer after the second layer is applied to a surface. For example, the viscosity of the second layer could be increased after coating by dissolving the composition of the second layer in a solvent, applying the composition onto the surface, and then removing the solvent from the composition prior to attaching the microstructural features of the third layer. The viscosity of the second layer could also be modified by partially crosslinking the composition after applying it onto the surface prior to attaching the microstructured surface of the third layer.

In some embodiments, the first, microstructured layer is provided by coating a resin upon a tooling surface, and curing the resin. In some embodiments, applying the second layer to the first, microstructured layer occurs when the first layer is still in contact with the tooling surface. In some embodiments, the laminating is performed while the first, microstructured layer is still in contact with the tooling surface. In some embodiments, the method further comprises removing the resulting first, second, and third layer composite from the tooling surface.

Crosslinkable compositions can be coated onto the desired surface (e.g., tooling surface or polymeric layer) using known coating techniques (e.g., die coating, gravure coating, screen printing, etc.).

In some embodiments, articles described herein have a thickness not greater than 80 micrometers (in some embodiments, not greater than 75 micrometers, 70 micrometers, 65 micrometers, 60 micrometers, 55 micrometers, 50 micrometers, 45 micrometers, or even not greater than 40 micrometers).

In some embodiments, articles described herein have an optical gain of greater than 2.0 (in some embodiments, greater than 2.1, 2.2 or even greater than 2.3) as measured by the “Measurement of Optical Gain” in the Examples.

The layers of the articles described herein are adhered sufficiently to allow the further processing of the article. For example, a temporary film (e.g., a premask film) may be laminated to an optical film to protect it in subsequent manufacturing processes. The optical film may be cut or converted to the desired shape, the protective film removed and the optical film may then be assembled into an optical display or sub-assembly. The layers of the articles described herein are adhered sufficiently to stay adhered through the converting step, the removal of the temporary film, and assembly into the optical display.

Articles described herein are useful, for example, for in optical film applications. For example, an article including a regular prismatic microstructured pattern can act as a totally internal reflecting film for use as a brightness enhancement film when combined with a back reflector; an article including a corner-cube prismatic microstructured pattern can act as a retroreflecting film or element for use as reflecting film; and an article including a prismatic microstructured pattern can act as an optical turning film or element for use in an optical display.

A backlight system can comprise a light source (i.e., a source capable of being energized or otherwise capable of providing light (e.g., LEDs)), a lightguide or waveplate, a back reflector, and at least one article described herein. Diffusers—either surface diffusers or bulk diffusers—may optionally be included within the backlight to hide visibility of cosmetic defects imparted through manufacturing or handling, or to hide hot spots, headlamp effects, or other non-uniformities. The backlight system may be incorporated, for example, into a display (e.g., a liquid crystal display). The display may include, for example, a liquid crystal module (including at least one absorbing polarizer), and a reflective polarizer (which may already be included in an embodiment of an article described herein).

### EXEMPLARY EMBODIMENTS

1A. An article comprising:

a first, microstructured layer comprising a first material, and having first and second opposed major surfaces, the first major surface being a microstructured surface, and the microstructured surface having peaks and valleys, wherein the peaks are microstructural features each having a height defined by the distance between the peak of the respective microstructural feature and an adjacent valley;

a second layer comprising an adhesive material, and having a first and second opposed major surfaces, wherein at least a portion of the second major surface of the second layer is directly attached to at least a portion of the first major, microstructured surface of the first layer; and

a third layer comprising at least one of a crosslinkable or crosslinked composition, and having first and second opposed major surfaces, wherein at least a portion of the second major surface of the third layer is directly attached to at least a portion of the first major surface of the second layer. In some embodiments, the third layer is a microstructured layer, wherein the first major surface is a microstructured surface, and the microstructured surface has peaks and valleys, wherein the peaks are microstructural features each having a height defined by the distance between the peak of the respective microstructural feature and an adjacent valley.

2A. The article of Exemplary Embodiment 1A, wherein a portion of each of the microstructural features of the first layer at least partially penetrates into the second material of the second layer (in some embodiments, the first layer at least partially penetrates into the second material of the second layer to a depth less the average height of the respective microstructural feature).
3A. The article of Exemplary Embodiment 2A, wherein the penetration depth of the each penetrating microstructural feature is not greater than 50 (in some embodiments, not greater than 45, 40, 35, 30, 25, 20, 15, 10, or even not greater than 5) percent of the respective height of the microstructural feature.
4A. The article of any preceding A Exemplary Embodiment, wherein the first material of the first, microstructured layer comprises at least one of a crosslinkable or crosslinked composition.
5A. The article of Exemplary Embodiments 1A to 3A, wherein the first, microstructured layer comprises the crosslinkable composition.
6A. The article of Exemplary Embodiments 1A to 3A, wherein the first, microstructured layer comprises the crosslinked composition.
7A. The article of Exemplary Embodiments 1A to 3A, wherein the first, microstructured layer consists essentially of the crosslinked material.
8A. The article of any of Exemplary Embodiments 1A to 3A, wherein the first material of the first, microstructured layer comprises a thermoplastic material.
9A. The article of any preceding A Exemplary Embodiments, wherein the third layer comprises the crosslinkable composition.
10A. The article of any of Exemplary Embodiments 1A to 8A, wherein the third layer comprises the crosslinked composition.
11A. The article of any of Exemplary Embodiments 1A to 8A, wherein the third layer consists essentially of the crosslinked material.
12A. The article of any preceding A Exemplary Embodiment, wherein the first, microstructured layer has a thickness defined by the smallest distance from any valley to the second major surface of the first, microstructured layer, and wherein the thickness is not greater than 25 micrometers (in some embodiments, not greater than 20 micrometers, 15 micrometers, or even not greater than 10 micrometers.
13A. The article of any preceding A Exemplary Embodiment, wherein the first, microstructured layer comprises at least one of a polymeric or crosslinkable material.
14A. The article of any preceding A Exemplary Embodiment, wherein the microstructural features of the first, microstructured layer are in the form of at least one of the following shapes: regular prismatic, irregular prismatic patterns (e.g., an annular prismatic pattern, a cube-corner pattern or any other lenticular microstructure), non-periodic protuberances, pseudo-non-periodic protuberances, or non-periodic depressions, or pseudo-non-periodic depressions.
15A. The article of any preceding A Exemplary Embodiment, wherein the height of a microstructural feature of the first layer is in the range from 1 micrometer to 200 micrometers (in some embodiments, in the range from 1 micrometer to 150 micrometers, 5 micrometers to 150 micrometers, or even 5 micrometers to 100 micrometers).
16A. The article of any preceding A Exemplary Embodiment, wherein the second major surfaces of the first, microstructured layer includes a microstructured surface.
17A. The article of any preceding A Exemplary Embodiment, wherein the third layer is a microstructured layer and has a thickness defined by the smallest distance from any valley to the second major surface of the first, microstructured layer, wherein the thickness is not greater than 25 micrometers (in some embodiments, not greater than 20 micrometers, not greater than 15 micrometers, or even not greater than 10 micrometers).
18A. The article of any preceding A Exemplary Embodiment, wherein the third, layer comprises at least one of a crosslinkable or crosslinked composition comprising an (meth)acrylate.
19A. The article of any preceding A Exemplary Embodiment, wherein the third layer is a microstructured layer with microstructural features in the form of at least one of the following shapes: regular prismatic, irregular prismatic patterns (e.g., an annular prismatic pattern, a cube-corner pattern or any other lenticular microstructure), non-periodic protuberances, pseudo-non-periodic protuberances, or non-periodic depressions, or pseudo-non-periodic depressions.
20A. The article of any preceding A Exemplary Embodiment, wherein the third layer is a microstructured layer with microstructural features having a heights in the range from 1 micrometer to 200 micrometers (in some embodiments, in the range from 1 micrometer to 150 micrometers, 5 micrometers to 150 micrometers, or even 5 micrometers to 100 micrometers).
21A. The article of any preceding A Exemplary Embodiment, wherein both the first and second major surfaces of the third layer each include a microstructured surface.
22A. The article of any preceding A Exemplary Embodiment, wherein the adhesive material of the second layer is at least one of an interpenetrating network of the reaction product of a polyacrylate component and a polymerizable monomer or a reaction product of a mixture comprising (meth)acrylate and epoxy in the presence of each other.
23A. The article of any preceding A Exemplary Embodiment, wherein the second layer further comprises a filler material (e.g., glass beads, polymer beads, inorganic particles such as fumed silica).
24A The article of any preceding A Exemplary Embodiment, further comprising a diffuser layer having first and second major surfaces, wherein the first major surface is attached to the second major surface of the first microstructured layer.
25A. The article of Exemplary Embodiment 24A, further comprising a second adhesive layer disposed between the first microstructured layer and the diffuser layer.
26A. The article of any preceding A Exemplary Embodiment, further comprising a first polymeric layer (e.g., a polyester layer or multilayer optical film (e.g., polarizing film or reflecting film)) having first and second major surfaces, wherein the first major surface is attached to the second major surface of the first, microstructured layer.
27A. The article of Exemplary Embodiment 26A, further comprising a first diffuser layer disposed between the first microstructured layer and the first polymeric layer.
28A. The article of Exemplary Embodiment 26A or 27A, further comprising a second diffuser layer having first and second major surfaces, wherein the first major surface is attached to the second major surface of the first polymeric layer.
29A. The article of Exemplary Embodiment 28A, further comprising a third adhesive layer disposed between the first polymeric layer and the second diffuser layer.
30A. The article of any preceding A Exemplary Embodiment, further comprising an fourth adhesive layer having first and second opposed major surfaces, wherein the second major surface of the fourth adhesive layer is attached to the first major surface of the third, microstructured layer.
31A. The article of any preceding A Exemplary Embodiment, further comprising a second polymeric layer (e.g., a polyester layer or multilayer optical film (e.g., polarizing film or reflecting film)) having first and second major surfaces, wherein the second major surface is attached to the first major surface of the fourth adhesive layer.
32A. The article of Exemplary Embodiment 31A, further comprising a fifth adhesive layer having first and second opposed major surfaces, wherein the second major surface of the fifth adhesive layer is attached to the first major surface of the second polymeric layer.
33A. The article of any preceding A Exemplary Embodiment, wherein the article has a thickness not greater than 80 micrometers (in some embodiments, not greater than 75 micrometers, 70 micrometers, 65 micrometers, 60 micrometers, 55 micrometers, 50 micrometers, 45 micrometers, or even not greater than 40 micrometers).
34A. The article of any preceding A Exemplary Embodiment having an optical gain greater than 2.0 (in some embodiments, greater than 2.1, 2.2, or even greater than 2.3).
35A. A backlight system comprising a light source, a back reflector, and at least one article of any preceding A Exemplary Embodiment.
1B. A method of making the article of any of Exemplary Embodiments 1A to 34A, the method comprising:

providing composite comprising first and second layers each having first and second opposed major surfaces, wherein the first major surface of the second layer is attached to the second major surface of the first layer; and

laminating a third layer having a first and second opposed major surfaces to the composite such that the first major surface of the third layer is attached to the second major surface of the second layer, wherein the first major surface of the third layer is a microstructured surface having microstructural features. In some embodiments, the first major surface of the first layer is a microstructured surface having microstructural features.

2B. The method of Exemplary Embodiment 1B, further comprising attaching a first polymeric layer (e.g., a polyester layer or multilayer optical film (e.g., polarizing film or reflecting film)) to the second major surface of the third layer.
3B. The method of Exemplary Embodiment 1B, wherein the third, microstructured layer is provided by coating a resin upon a tooling surface, curing the resin, and removing the third, microstructured layer from the tooling surface, wherein the tooling surface is a mold for forming the microstructured first major surface of the microstructured third layer.
4B. The method of Exemplary Embodiment 3B, further comprising attaching the first polymeric layer to the second major surface of the third, microstructured layer prior to curing the resin.
5B. The method of Exemplary Embodiment 1B, wherein during the laminating the microstructural features of the microstructured surface of the third layer penetrate into the second major surface of the second layer.
6B. The method of any preceding B Exemplary Embodiment, wherein the first, microstructured layer is provided by coating a resin upon a tooling surface, and curing the resin.
7B. The method of Exemplary Embodiment 6B, wherein applying the second layer to the first, micro structured layer occurs when the first layer is still in contact with the tooling surface.
8B. The method of Exemplary Embodiment 7B, wherein the laminating is performed while the first, micro structured layer is still in contact with the tooling surface.
9B. The method of Exemplary Embodiment 8B, further comprising removing the resulting first, second, and third layer composite from the tooling surface.

Advantages and embodiments of this invention are further illustrated by the following examples, but the particular materials and amounts thereof recited in these examples, as well as other conditions and details, should not be construed to unduly limit this invention. All parts and percentages are by weight unless otherwise indicated.

### EXAMPLES

### Test Methods

Measurement of Optical Gain

Optical gain was measured by placing the film or film laminate on top of a diffusively transmissive hollow light box. The diffuse transmission and reflection of the light box were approximately Lambertian. The light box was a six-sided hollow rectangular solid of dimensions 12.5 cm by 12.5 cm by 11.5 cm made from diffuse polytetrafluoroethylene (PTFE) plates about 0.6 mm thick. One face of the box was designated as the sample surface. The hollow light box had a diffuse reflectance of about 0.83% measured at the sample surface averaged over the 400-700 nm wavelength range.

During the gain test, the box was illuminated from within through a circular hole about 1 cm in diameter in the surface of the box opposite the sample surface, with the light directed toward the sample surface. The illumination was provided by a stabilized broadband incandescent light source attached to a fiber optic bundle used to direct the light (obtained under the trade designation “FOSTEC DCR-III” from Schott North America, Southbridge Mass.) with a one cm diameter fiber bundle extension (obtained under the trade designation “SCHOTT FIBER OPTIC BUNDLE” from Schott North America). A linear absorbing polarizer (obtained under the trade designation “MELLES GRIOT 03 FPG 007” from CVI Melles Griot, Albuquerque, N. Mex.) was mounted on a rotary stage (obtained under the trade designation “ART310-UA-G54-BMS-9DU-HC” from Aerotech, Pittsburgh, Pa.) and placed between the sample and the camera. The camera was focused on the sample surface of the light box at a distance of about 0.28 meter and the absorbing polarizer was placed about 1.3 cm from the camera lens.

The luminance of the illuminated light box, measured with the polarizer in place and no sample films in place was greater than 150 candela per square meters (cd/m²). The sample luminance was measured with a spectrometer (obtained under the trade designation “EPP2000” from StellarNet Inc., Tampa, Fla.) connected to a collimating lens via a fiber optic cable (obtained under the trade designation “F1000-VIS-NIR” from StellarNet Inc.); the spectrometer was oriented at normal incidence to the plane of the box sample surface when the sample films were placed on the sample surface. The collimating lens was composed of a lens tube (obtained under the trade designation “SM1L30” from Thorlabs, Newton, N.J.) and a plano-convex lens (obtained under the trade designation “LA1131” from Thorlabs); the setup was assembled to achieve a focused spot size of 5 mm at the detector. Optical gain was determined as the ratio of the luminance with the sample film in place to the luminance from the light box with no sample present. For all films, optical gain was determined at polarizer angles of 0, 45, and 90 degrees relative the sample orientation. For samples that do not contain a reflective polarizing film, the average optical gain of the values measured at 0 and 90 degrees was reported. For samples that do contain a reflective polarizing film, the maximum optical gain was reported.

Measurement of Thickness

Thickness was measured with a digital indicator (obtained under the trade designation “ID-F125E” from Mitutoyo America, Aurora, Ill.) mounted on a granite base stand (obtained under the trade designation “CDI812-1” from Chicago Dial Indicators Co., Inc., Des Plaines, Ill.). The digital indicator was zeroed while in contact with the granite base. Five measurements of the sample thickness were measured at the corners and center of a 3 cm by 3 cm square. The average of the five thickness measurements was reported.

Scanning Electron Micrograph Images

Scanning electron microscopy images were obtained by metallizing the sample in a vacuum chamber (obtained under the trade designation “DENTON VACUUM DESK II” from Denton Vacuum LLC, Moorestown, N.J.) and imaging in a scanning electron microscope (obtained under the trade designation “PHENOM PURE” Model PW-100-010 from Phenom-World BV, The Netherlands).

Preparation of Tooling Surface A

A tooling surface was prepared by treating the microreplicated surface of a brightness enhancement film (obtained under the trade designation “VIKUTI THIN BRIGHTNESS ENHANCEMENT FILM (TBEF) II 90/24” film from 3M Company) in a tetramethylsilane and oxygen plasma as described in Example 4 of U.S. Pat. No. 9,102,083 B2 (David et al.), the disclosure of which is incorporated herein by reference. The brightness enhancement was primed with argon gas at a flow rate of 250 standard cubic centimeters per minute (SCCM), a pressure of 25 milliTorr (mTorr) and RF power of 1000 Watts (W) for 30 seconds. Subsequently, the film was exposed to tetramethylsilane (TMS) plasma at a TMS flow rate of 150 SCCM. The pressure in the chamber was 25 mTorr and the RF power was 1000 W for 10 seconds.

Preparation of Tooling Surface B

A prism film was made as generally described in U.S. Pat. No. 5,175,030 (Lu et al.) and U.S. Pat. No. 5,183,597 (Lu), the disclosure of which is incorporated herein by reference. Specifically, the prism film was made using crosslinkable resin Composition E (described below) and a master tool with prisms with a 90 degree angle spaced every 0.048 mm (48 micrometers) that was produced according to the process described in U.S. Pat. Pub. No. 2009/0041553 (Burke et al.), the disclosures of which are incorporated herein by reference. A tooling surface was prepared by treating the microreplicated surface of the prism film in a low pressure plasma chamber. After removal of the air from the chamber, perfluorohexane (“C6F14”) and oxygen were introduced to the chamber at flow rates of 600 and 300 SCCM, respectively with a total chamber pressure of 10 mTorr. The film was treated with RF power of 8000 W as the film moved through the treatment zone at 9.14 m/min.

Preparation of Crosslinkable Resin Composition A

A crosslinkable resin composition was prepared according to Example 2 of U.S. Pat. No. 8,282,863 B2 (Jones, et. al.) the disclosure of which is incorporated herein by reference.

Preparation of Crosslinkable Resin Composition B

A crosslinkable resin composition was prepared by mixing 45 parts by weight of epoxy (obtained under the trade designation “CELLOXIDE 2021P” from Diacel, Fort Lee, N.J.), 20 parts by weight polyol (obtained under the trade designation “CAPA 2043” from Perstorp, Malmo, Sweden) 35 parts by weight (meth)acrylate (obtained under the trade designation “SR499” from Sartomer Company), 1 part by weight initiator (obtained under the trade designation “DAROCUR 4265” from BASF Corporation), and 2 parts by weight initiator (obtained under the trade designation “TRIARYLSULFONIUM HEXAFLUOROANTIMONATE” from Sigma Aldrich, St Louis, Mo.).

Preparation of Crosslinkable Resin Composition C

A crosslinkable resin composition was prepared using the components in Table 1 (below) at the indicated weight ratios.

TABLE 1

| Component | | | |
|---|---|---|---|
| (Obtained under | | | Parts by |
| trade designation) | Supplier | Description | Weight |
| “POLYACRYLATE | 3M Company, St Paul, | Terpolymer of isooctyl acrylate (50 | 62.32 |
| PSA” | MN | weight %), ethyl acrylate (40 weight | |
| | | %), and acrylic acid (10 weight %) | |
| | | having an instrinsic viscosity of 1.9. | |
| “CELLOXIDE | Diacel, Fort Lee, NJ | (3-4-epoxycyclohexane) methyl 3′- | 3.16 |
| 2021P” | | 4′-epoxycyclohexyl-carboxylate | |
| “DIETHYL | Sigma, Aldrich, St | Diethyl phthalate | 0.53 |
| PHTHALATE” | Louis, MO | | |
| “OPPI SbF6” | Hamford Research | (4-octyloxyphenyl) phenyliodonium | 0.44 |
| | Inc. Stratford, CT | hexafluoroantimonate | |
| “ADDITOL ITX” | Allnex, Brussels, | Isoprophyl thioxanthone (2 and 4 | 0.01 |
| | Belguim | isomer mixture) | |
| | Sigma-Aldrich | Toluene | 13.75 |
| | Sigma-Aldrich | Methanol | 9.84 |
| | Sigma-Aldrich | Ethyl Acetate | 39.93 |

The toluene, methanol, and ethyl acetate were added first. The polyacrylate PSA, (3-4-epoxycyclohexane) methyl 3′-4′-epoxycyclohexyl-carboxylate (“CELLOXIDE 2021P”) and diethyl phthalate (“DIETHYL PHTHALATE”) where then added followed by the isoprophyl thioxanthon (“ITX”) and (4-octyloxyphenyl) phenyliodonium hexafluoroantimonate (“SBF6 OPPI”). The composition was then mixed for 2 hours with a high speed mixer (obtained under the trade designation “SERVODYNE” from Cole-Palmer Instrument Company, LLC, Vernon Hills, Ill.) operating at 500 revolutions per minute.

Preparation of Crosslinkable Resin Composition D

A crosslinkable resin composition was prepared by adding 0.44 gram of polymethyl methacrylate beads (obtained under the trade designation “TS3SC” from Soken Chemical and Engineering Company, Limited, Tokyo, Japan) to 3.56 grams of ethyl acetate. This suspension was added to 50 grams of crosslinkable resin Composition C and then shaken.

Preparation of Crosslinkable Resin Composition E

A crosslinkable resin composition was prepared by mixing 75 parts by weight epoxy acrylate (obtained under the trade designation “CN 120” from Sartomer Company) 25 parts by weight of 1,6 hexanediol diacrylate (obtained under the trade designation “SR 238” from Sartomer Company) 0.25 part by weight initiator (obtained under the trade designation “DAROCUR 1173” from BASF Corporation) and 0.1 part by weight initiator (obtained under the trade designation “IRGACURE TPO” from BASF Corporation).

### Example 1

A bead of the crosslinkable resin Composition A was placed on tooling surface A. A piece of 0.125 mm (125 micrometer) thick conventional biaxially-oriented polyester film was placed over the crosslinkable resin composition and a laminator (obtained under the trade designation “GBC CATENA 35” from ACCO Brands Corporation, Lake Zurick, Ill.) was used to spread the crosslinkable resin composition. The construction was then exposed to UV light from a UV curing system (obtained under the trade designation “FUSION UV CURING SYSTEM” with a D bulb and an “H” bulb from Fusion UV Systems, Inc., Gaithersburg, Md.) operating at 6000 watts and a speed of 9.2 m/min. The polyester film was then removed, leaving a microstructured layer (referred to hereinafter in this example as the “third layer”) on the tooling surface.

A first microstructured layer was made as described for the third microstructured layer. After removing the polyester film, the first microstructured layer was transferred to the primed side of a piece of 0.125 mm (125 micrometers) thick biaxially-oriented polyester film having an adhesion promoting primer coating (obtained under the trade designation “RHOPLEX 3208” from Dow Chemical Company, Midland, Mich.) on which two strips of double sided adhesive tape (obtained under the trade designation “SCOTCH 137 DOUBLE SIDED TAPE” from 3M Company) were applied about 15 cm apart.

Crosslinkable resin Composition C was coated onto the smooth side of the third microstructured layer (while it remained on the tooling surface) by placing a bead of crosslinkable Composition C along one edge and spreading it with a wire wound rod (obtained under the trade designation “#12 WIRE WOUND ROD” from R.D. Specialties, Webster, N.Y.). The sample was placed in a 65.5° C. (150° F.) oven for 2 minutes. The microstructured surface of the first microstructured layer was then laminated to the crosslinkable Composition C with the prisms of the first microstructured layer oriented approximately perpendicular to the prisms of the third microstructured layer. The laminated construction was then exposed to UV light from a UV curing system (“FUSION UV CURING SYSTEM”) with an H bulb and a D bulb both operating at 6000 watts at a speed of 9.2 m/min. The resulting Example 1 article was generated by removing the tooling surface from the third microstructured layer and the polyester film from the first microstructured layer. The thickness of the Example 1 article was measured at 0.037 mm and the average optical gain was measured at 2.15.

Cross-sections of the Example 1 article were cut with a razor blade approximately parallel and perpendicular to the first microstructured layer. FIG. 2A is a SEM photomicrograph of the Example 1 article at 1900× cut perpendicular to the prisms of the first microstructured layer. FIG. 2B is a SEM photomicrograph of the Example 1 article at 1900× cut perpendicular to the prisms of the third microstructured layer.

### Example 2

A bead of crosslinkable Composition A was placed on tooling surface A. Conventional 0.050 mm (50 micrometers) thick biaxially-oriented polyester film was laminated over the crosslinkable resin with a hand roller. The construction was then exposed to UV light from a UV curing system (“FUSION UV CURING SYSTEM”) with a D bulb operating at 3600 watts at a speed of 7.6 m/min. The polyester film was removed leaving a microstructured layer (referred to hereinafter in this example as the “third layer”) on the tooling surface.

A bead of the crosslinkable Composition B was placed onto the smooth side of the third microstructured layer and spread with a wire wound rod (obtained under the trade designation “#3 WIRE WOUND ROD” from R.D. Specialties). The resulting construction was then exposed to UV from a UV source (obtained under the trade designation “FIREPOWER FP501” from Phoseon Technology Inc. Hillboro, Oreg.) operating at 100% power by passing the construction under the UV source in a nitrogen purged atmosphere at a distance of 1.9 cm and a speed of 7.6 m/min.

A first microstructured layer was prepared by placing a bead of crosslinkable Composition A onto tooling surface A. Conventional 0.050 mm thick biaxially-oriented polyester film was laminated over the crosslinkable resin with a hand roller. The construction was then exposed to UV light from a UV curing system (“FUSION UV CURING SYSTEM”) with a D bulb operating at 3600 watts at a speed of 7.6 m/min. The tooling surface was removed leaving the first microstructured layer on the polyester film.

The microstructured surface of the first microstructured layer was laminated to crosslinkable Composition B. The prisms of the first and third microstructured layers were oriented approximately orthogonal to each other. The resulting construction was then exposed to UV light from a UV curing system (“FUSION UV CURING SYSTEM”) with a D bulb operating at 3600 watts and a speed of 7.6 m/min. The resulting Example 2 article was generated by removing the tooling film from the third microstructured layer and the polyester film from the first microstructured layer. The optical gain of the Example 2 article was measured at 1.82 and the thickness was measured at 0.095 mm.

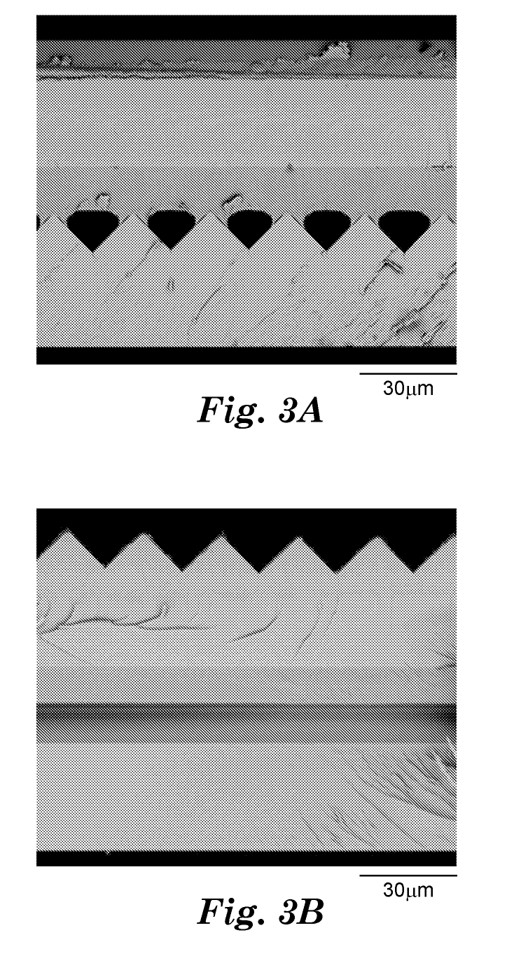

Cross-sections of the Example 2 article were cut with a razor blade approximately parallel and perpendicular to the first microstructured layer. FIG. 3A is a SEM photomicrograph of the Example 2 article at 1900× cut perpendicular to the prisms of the first microstructured layer. FIG. 3B is a SEM photomicrograph of the Example 2 article at 1900× cut perpendicular to the prisms of the third microstructured layer.

### Example 3

A microstructured layer (referred to hereinafter in this example as the “third layer”) was made and placing a bead of the crosslinkable resin Composition A on tooling surface A. A piece of 0.125 mm (125 micrometer) thick conventional biaxially-oriented polyester film was placed over the crosslinkable resin composition and a laminator (“GBC CATENA 35”) was used to spread the crosslinkable resin composition. The construction was then exposed to UV light from a UV curing system (“FUSION UV CURING SYSTEM”) with a D bulb and an “H” bulb operating at 6000 watts and a speed of 9.2 m/min. The polyester film was then removed.

Crosslinkable resin Composition D was coated onto the smooth side of the third microstructured layer while it remained on the tooling surface by placing a bead of crosslinkable Composition D along one edge and spreading it with a wire wound rod (“#12 WIRE WOUND ROD”). The sample was placed in a 65.5° C. (150° F.) oven for 2 minutes to dry.

A first microstructured layer was prepared as generally described in U.S. Pat. No. 5,175,030 (Lu et al.) and U.S. Pat. No. 5,183,597 (Lu), the disclosures of which are incorporated herein by reference. More specifically the first microstructured layer was a prism film described in U.S. Pat. Pub. No. 2013/0004728 (Boyd et al.), the disclosure of which is incorporated herein by reference. The microstructured layer included the bonding portions described in U.S. Pat. Pub. No. 2013/0004728 (Boyd et al.) on each prism. The prisms had a 90 degree angle and were spaced every 0.024 mm (24 micrometer). A 0.050 mm (50 micrometer) thick conventional biaxially-oriented polyester film with an adhesion promoter (“RHOPLEX 3208”) and crosslinkable resin Composition E was used.

The microstructured surface of the first microstructured layer was laminated to the crosslinkable resin Composition D on the third microstructured layer. The prisms of the first microstructured layer were oriented approximately perpendicular to the prisms in the third microstructured layer. The laminated construction was then exposed to UV light from a UV curing system (“FUSION UV CURING SYSTEM”) with an H bulb and D bulb both operating at 6000 watts at a speed of 9.2 m/min. The resulting Example 3 article was generated by removing the tooling surface. The thickness of the Example 3 article was measured at 0.070 mm and the average optical gain was measured at 2.02.

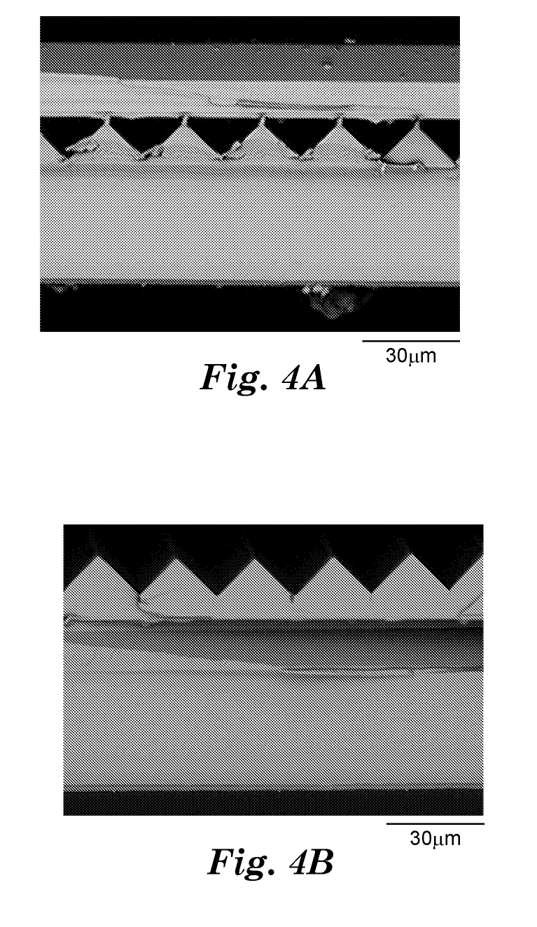

Cross-sections of the Example 3 article were cut with a razor blade approximately parallel and perpendicular to the first microstructured layer. FIG. 4A is a SEM photomicrograph of the Example 3 article at 1900× cut perpendicular to the prisms of the first microstructured layer. FIG. 4B is a SEM photomicrograph of the Example 3 article at 1900× cut perpendicular to the prisms of the third microstructured layer.

### Example 4

A third microstructured layer was made by placing a bead of the crosslinkable resin Composition A on tooling surface A. A piece of 0.125 mm (125 micrometer) thick conventional biaxially-oriented polyester film was placed over the crosslinkable resin composition and a laminator (“GBC CATENA 35”) was used to spread the crosslinkable resin composition. The construction was then exposed to UV light from a UV curing system (“FUSION UV CURING SYSTEM”) with a D bulb and an H bulb both operating at 6000 watts at a speed of 9.2 m/min. The polyester film was removed.

Crosslinkable resin Composition D was coated onto the smooth side of the third microstructured layer (while it remained on the tooling surface) by placing a bead of crosslinkable Composition D along one edge and spreading it with a wire wound rod (“#12 WIRE WOUND ROD”). The sample was placed in a 65.5° C. (150° F.) oven for 2 minutes.

A first microstructured layer was prepared as the first microstructured layer in Example 3 with the following exceptions: every other prism was larger, the prisms between the larger prisms were smaller and the bonding features were only present on the larger prisms. The microstructured surface of the first microstructured layer was laminated to the crosslinkable Composition D on the third microstructured film layer. The prisms of the first microstructured layer were oriented approximately perpendicular to the prisms of the third microstructured layer. The laminated construction was then exposed to UV light from a UV curing system (“FUSION UV CURING SYSTEM”) with an H bulb and D bulb both operating at 6000 watts at a speed of 9.2 m/min. The Example 4 article was generated by removing the tooling surface. The thickness of the Example 4 article was measured at 0.083 mm and the average optical gain was measured at 2.1.

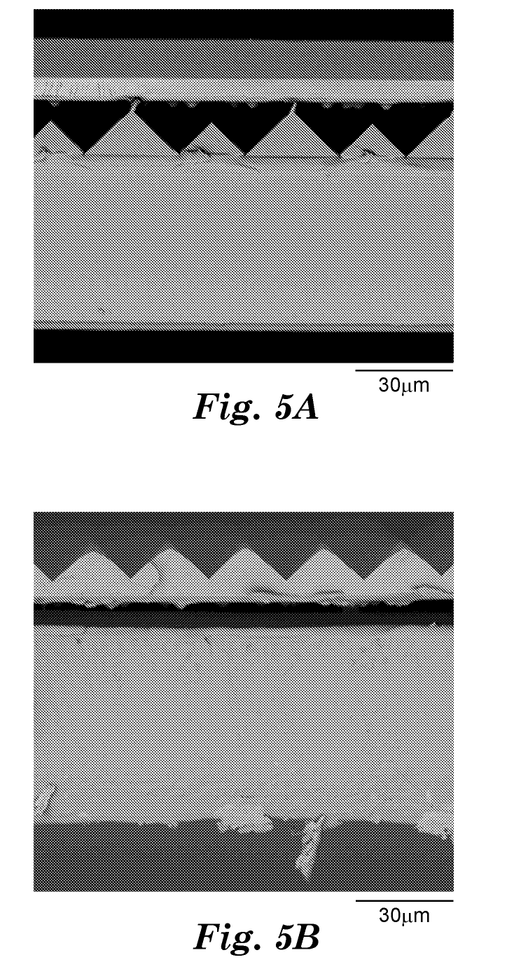

Cross-sections of the Example 4 article were cut with a razor blade approximately parallel and perpendicular to the first microstructured layer. FIG. 5A is a SEM photomicrograph of the Example 4 article at 1900× cut perpendicular to the prisms of the first microstructured layer. FIG. 5B is a SEM photomicrograph of the Example 4 article at 1900× cut perpendicular to the prisms of the third microstructured layer.

### Example 5

A bead of crosslinkable Composition E was placed on a metal tooling surface comprising prisms with a 90 degree angle spaced every 0.024 mm (24 micrometers) similar to the pattern on brightness enhancement film (obtained under the trade designation “VIKUTI THIN BRIGHTNESS ENHANCEMENT FILM (TBEF) II 90/24” film from 3M Company). Reflective polarizer film (obtained under the trade designation “ADVANCED POLARIZING FILM V4” from 3M Company) was laminated over the crosslinkable resin composition while the tooling surface was on 60° C. plate. The construction was exposed to UV light from a UV curing system (“FUSION UV CURING SYSTEM’) with an H bulb and D bulb both operating at 6000 watts at a speed of 18.3 m/min. The first microstructured layer was removed from the tooling surface.

A bead of the crosslinkable Mixture E was placed onto tooling surface B. Conventional 0.125 mm (125 micrometer) thick biaxially-oriented polyester film was laminated over the curable mixture with a hand roller. The construction was exposed to UV light from a UV curing system (“FUSION UV CURING SYSTEM’) with an H bulb and D bulb both operating at 6000 watts at a speed of 18.3 m/min. The polyester film was removed leaving the third microstructured layer on the tooling surface.

A bead of crosslinkable resin Composition C was placed on smooth side of the third microstructured layer and spread with a wire wound rod (obtained under the trade designation “#18 WIRE WOUND ROD” from R.D. Specialties). The sample was placed in a 65.5° C. (150° F.) oven for 2 minutes. The microstructured surface of the first microstructured layer was laminated to crosslinkable resin Composition C. The prisms of the first microstructured layer were oriented approximately perpendicular to the prisms of the third microstructured layer. The construction was exposed to UV light from a UV curing system (“FUSION UV CURING SYSTEM’) with an H bulb and D bulb both operating at 6000 watts at a speed of 18.3 m/min. The resulting Example 5 article was prepared by removing the tooling surface.

The optical gain of the Example 5 article was measured at 2.39 and the thickness was measured at 0.056 mm.

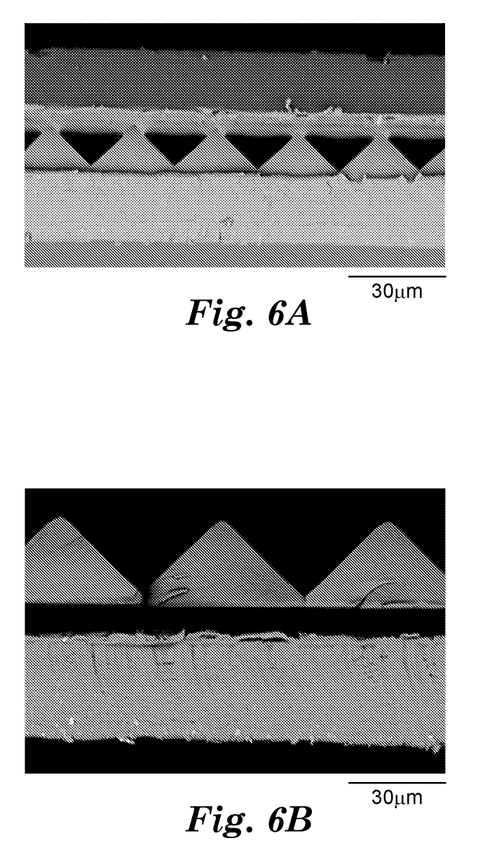

Cross-sections of the Example 5 article were cut with a razor blade approximately parallel and perpendicular to the first microstructured layer. FIG. 6A is a SEM photomicrograph of the Example 5 article at 2000× cut perpendicular to the prisms of first microstructured layer. FIG. 6B is a SEM photomicrograph of the Example 5 article at 2000× cut perpendicular to the prisms of the third microstructured layer.

Foreseeable modifications and alterations of this disclosure will be apparent to those skilled in the art without departing from the scope and spirit of this invention. This invention should not be restricted to the embodiments that are set forth in this application for illustrative purposes.

1. An article comprising:
a first, microstructured layer comprising a first material, and having first and second opposed major surfaces, the first major surface being a microstructured surface, and the microstructured surface having peaks and valleys, wherein the peaks are microstructural features each having a height defined by the distance between the peak of the respective microstructural feature and an adjacent valley;
a second layer comprising an adhesive material, and having a first and second opposed major surfaces, wherein at least a portion of the second major surface of the second layer is directly attached to at least a portion of the first major, microstructured surface of the first layer; and
a third, microstructured layer comprising at least one of a crosslinkable or crosslinked composition, and having first and second opposed major surfaces, the first major surface being a microstructured surface, and the microstructured surface having peaks and valleys, wherein the peaks are microstructural features each having a height defined by the distance between the peak of the respective microstructural feature and an adjacent valley, wherein at least a portion of the second major surface of the third layer is directly attached to at least a portion of the first major surface of the second layer.

2. The article of claim 1, wherein a portion of each of the microstructural features of the first layer at least partially penetrates into the second material of the second layer.

3. The article of claim 2, wherein the penetration depth of the each penetrating microstructural feature is not greater than 50 percent of the respective height of the microstructural feature.

4. The article of claim 1, wherein the first material of the first, microstructured layer comprises at least one of a crosslinkable or crosslinked composition.

5. The article of claim 1, wherein the first material of the first, microstructured layer comprises a thermoplastic material.

6. The article of claim 1, wherein the first, microstructured layer has a thickness defined by the smallest distance from any valley to the second major surface of the first, microstructured layer, and wherein the thickness is not greater than 25 micrometers.

7. The article of claim 1, wherein the third, microstructured layer has a thickness defined by the smallest distance from any valley to the second major surface of the first, microstructured layer, wherein the thickness is not greater than 25 micrometers.

8. The article of claim 1, wherein the adhesive material of the second layer is at least one of an interpenetrating network of the reaction product of a polyacrylate component and a polymerizable monomer or a reaction product of a mixture comprising (meth)acrylate and epoxy in the presence of each other.

9. The article of claim 1, wherein the article has a thickness not greater than 80 micrometers.

10. A backlight system comprising a light source, a back reflector, and at least one article of claim 1.
